(19) United States
(12) Patent Application Publication
(10) Pub. No.: US 2014/0157900 A1
(43) Pub. Date: Jun. 12, 2014

(54) METHOD OF CHARACTERIZING AN ADHESIVE BOND

(71) Applicant: SNECMA, Paris (FR)

(72) Inventor: Jean-Yves Francois Roger CHATELLIER, Arcueil (FR)

(73) Assignee: SNECMA, Paris (FR)

(21) Appl. No.: 14/090,035

(22) Filed: Nov. 26, 2013

(30) Foreign Application Priority Data
Dec. 7, 2012 (FR) 12 61789

(51) Int. Cl. G01N 29/04

(52) U.S. Cl. CPC G01N 29/04
USPC 73/588

(57) ABSTRACT

The invention relates to a method of characterizing an adhesive bond, the method comprising a step of recording an ultrasound wave reflected by an adhesive bond interface between two fragments, a step of resolving said wave into its sinusoidal components in order to characterize a mode of breaking to be expected in the event of the adhesive bonding interface breaking in shear.

### TECHNICAL FIELD AND PRIOR ART

The invention lies in the field of methods of characterizing components in mechanical industry, and in particular in aviation industry. The components of interest are assemblies of adhesively bonded fragments, and the invention seeks to characterize the adhesive bonding interface between the fragments. Particularly, but not exclusively, the parts under study may be parts made of composite materials.

The adhesive bonding under consideration is bonding using films of structural adhesive. There is a known method of characterizing adhesively bonded interfaces. That method consists in subjecting the interface to shear stresses until it breaks, and then in viewing the interface after it has broken, so as to determine the percentage of the area of the interface that has broken by cohesive breaking, and the percentage of the area of the interface that has broken by adhesive breaking.

Such a method is destructive and has the drawback of needing to be performed on test-pieces and not on real parts. Test-pieces are standardized, and their dimensions do not correspond to those of a real part. Neither the bonded fragments, nor the adhesive joints of the adhesively bonded interfaces correspond to real parts. Furthermore, the nature of the material of the test-pieces and of the adhesive fluctuates from batch to batch, and the same applies to the working of the adhesive and the thickness of the final adhesive joint. Under such conditions, it is difficult to be sure that the characterization performed on a test-piece can be generalized to the real parts that it is desired to simulate.

The invention seeks to solve this problem and to propose a non-destructive technique for characterizing an adhesively bonded interface between two fragments.

### Definition of the Invention and the Associated Advantages

In order to solve this problem, there is provided a method of characterizing an adhesive bond, the method comprising a step of recording an ultrasound wave reflected by an adhesive bond interface between two fragments, and a step of resolving said wave into its sinusoidal components in order to characterize a mode of breaking to be expected in the event of the adhesive bonding interface breaking in shear. By means of this method, a nondestructive technique is made available for determining the characteristics of an adhesive bond, specifically on an example of a component.

It is specified that in one implementation, a wave is generated in emission/reflection mode in order to obtain the reflected wave, and a longitudinal wave is generated in order to obtain the reflected wave. Advantageously, the recording comprises recording at least seven successive echoes.

For example, the determination is performed by comparing the amplitude of the maximum-amplitude sinusoidal component with predetermined ultrasound wave amplitude values, and/or by applying a linear relationship to the amplitude of the maximum-amplitude sinusoidal component. By way of example, the method is performed on a real aeroengine part, and it may be performed in order to develop an adhesive for adhesively bonding two fragments together. The braking mode is advantageously characterized by adhesive breaking and cohesive breaking percentages.

In an implementation aspect, the electronic gate used for the recording has a field that includes the successive echoes in the material of the fragment through which the reflected wave passes, but not the echo from the interface between the water and the surface of said fragment.

The invention is described below with reference to the accompanying figures.

### BRIEF DESCRIPTION OF THE FIGURES

FIG. 1 shows a test-piece used during the calibration stage of the invention.

FIG. 2 shows arrangements used during the calibration stage of the invention.

FIG. 3 shows breaking patterns of the adhesive bonding interfaces of various test-pieces.

FIG. 4 shows a later step of the calibration stage of the invention.

FIG. 5 shows an analysis of the data obtained during the step of FIG. 4.

FIG. 6 shows a chart established during the calibration stage.

FIG. 7 shows the method of the invention, as performed on a component of made up of two fragments that are adhesively bonded together.

### DETAILED DESCRIPTION OF THE INVENTION

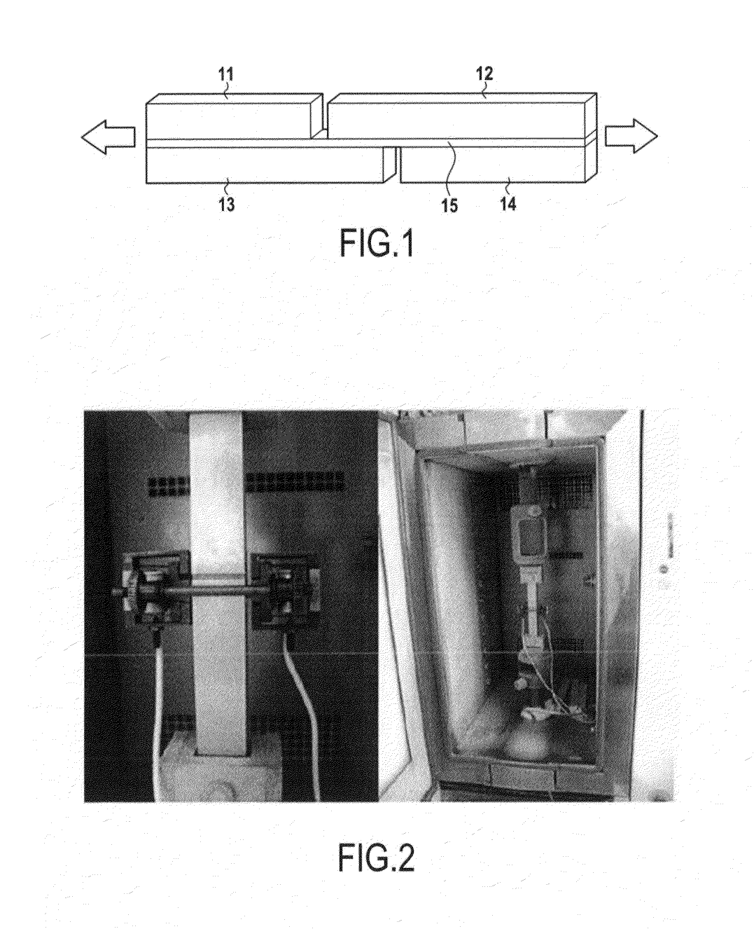

The prior art technique is shown in FIGS. 1 to 3.

FIG. 1 shows a test-piece used for the calibration needed for performing the prior art method. It is constituted by two fragments 12 and 13, each in the form of a rectangular parallelepiped, the fragments being assembled together with fragments of aluminum 11 and 14, likewise in the form of rectangular parallelepipeds, all four fragments having sections of the same dimensions.

The test-piece is obtained by cutting plates that have been adhesively bonded in a press. The fragments 11 and 12 are in alignment along with their long dimensions with a gap between them, and the fragments 13 and 14 are likewise in alignment along their long dimensions, likewise with a gap between them. A film of adhesive 15 connects together the fragments 11 and 12 and also the fragments 13 and 14, the two gaps not being in register with each other, but being offset. Thus, the fragments 11 and 13 are adhesively bonded together over a long length, as are the fragments 12 and 14. However the fragments 12 and 13 are adhesively bonded together along a short length, referred to as the “effective section”. This is an overlap zone between these two fragments. The fragments 11 and 14 are not adhesively bonded together.

For calibration, traction tests in shear are performed in a tensile test machine fitted with a 100 kilo newton (kN) measurement cell. The extensometer used is shown in FIG. 2, together with the enclosure of the tensile test machine.

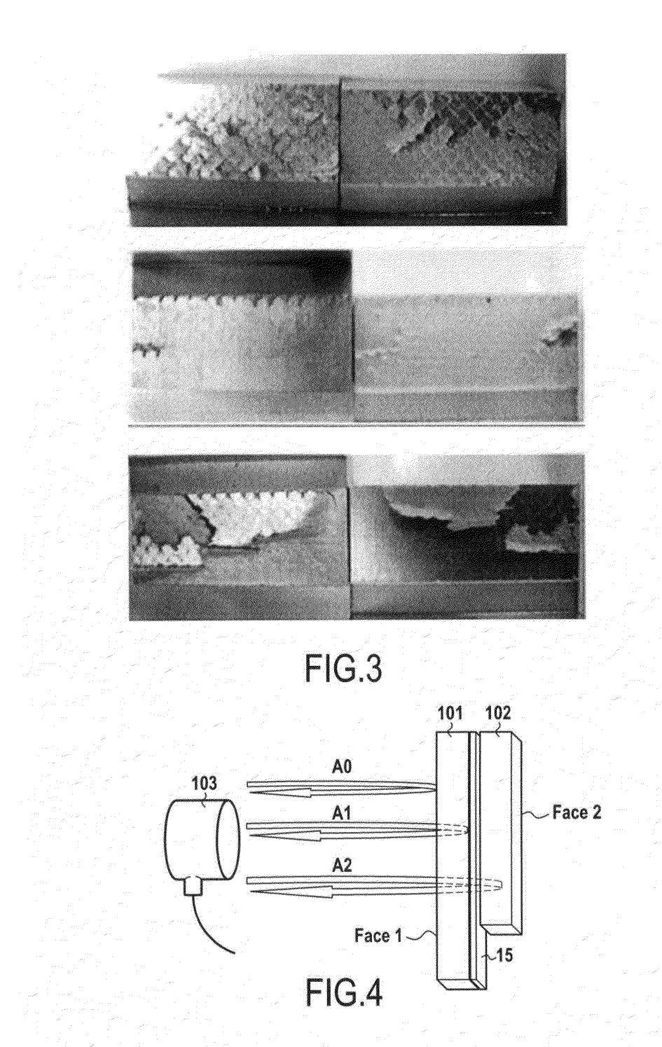

FIG. 3 shows various breaking patterns of test-pieces that have been subjected to a shear test. In each example, the left and right portions are photographs of the surfaces of the fragments 12 and 13 in contact with the film of adhesive 15. From top to bottom, there can be seen patterns with 70% cohesive breaking and 30% adhesive breaking, 100% adhesive breaking, and 50% cohesive breaking with 50% adhesive breaking.

FIG. 4 shows how the calibration stage continues.

Use is made of the elements obtained by breaking the structure shown in FIG. 1. Thus, there is a fragment 101 of the material under study, corresponding to the fragment 12 or 13 of FIG. 1, which is adhesively bonded by the film 15 to a fragment 102 that corresponds to the fragment 11 or 14. An ultrasound transducer 103 is directed towards the surface of the fragment 101 that is remote from the film 15 (face 1), which transducer is a plane Panametrics V313 15/0.25″ sensor, for example. It emits a longitudinal ultrasound wave propagating in a direction perpendicular to the interface constituted by the film of adhesive 15. The pulse vibrates at a frequency of 16.7 megahertz (MHz). A portion A0 of this wave is reflected on the outside surface of the fragment 101, and therefore does not penetrate into the material. It therefore performs no more than a go and return trip through the water between the transducer 103 and the surface of the fragment 101.

A second portion A1 penetrates into the fragment 101 and is reflected by the interface constituted by the film of adhesive 15. It passes back through the fragment 101, leaves the fragment, and travels the distance between the fragment and the transducer 103.

A third portion A2 passes through the interface constituted by the film of adhesive 15 and is reflected by the opposite face of the fragment 102 (face 2). It thus passes in the opposite direction through the fragment 102 and the fragment 101, and likewise travels the distance between the fragment 101 and the transducer 103.

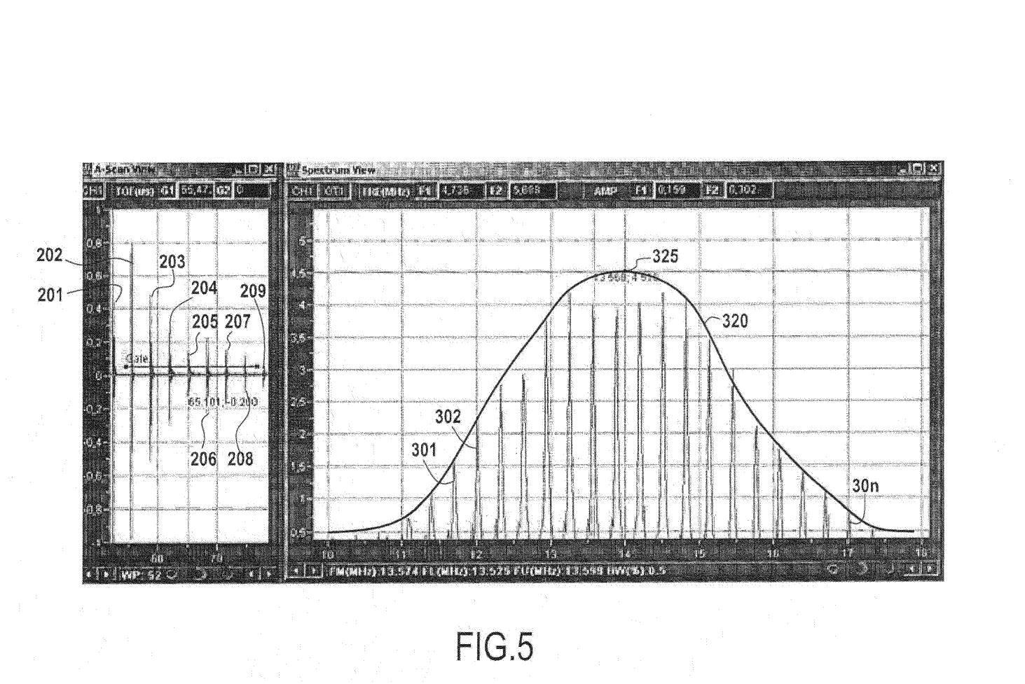

Using the transducer 103 in transceiver mode, a series of echoes are recorded that come from the thickness of the fragment 101, which in this example is about 10 millimeters (mm), with measurement being to within 1 micrometer (μm). The echoes are shown in the left portion of FIG. 5, as a function of time, and numbered 201 to 209. They are of decreasing amplitude. Only those that originate from within the thickness of the fragment 101 are concerned, i.e. in this example the echoes 202 to 208, and the echo 201 originating from the outside surface of the fragment 101 (face 1) is excluded, this echo corresponding to the above-mentioned portion A0 of the wave.

A Fourier transform is performed on the accumulated echoes 202 to 208, thereby revealing multiple resonances. Resonance is associated with the quality of the adhesive and cohesive bond. There can be seen a set of resonance peaks 301, 302, . . . , 30n, having an envelope 320 forming a Gaussian curve. The amplitude of the maximum 325 of this envelope is then measured accurately.

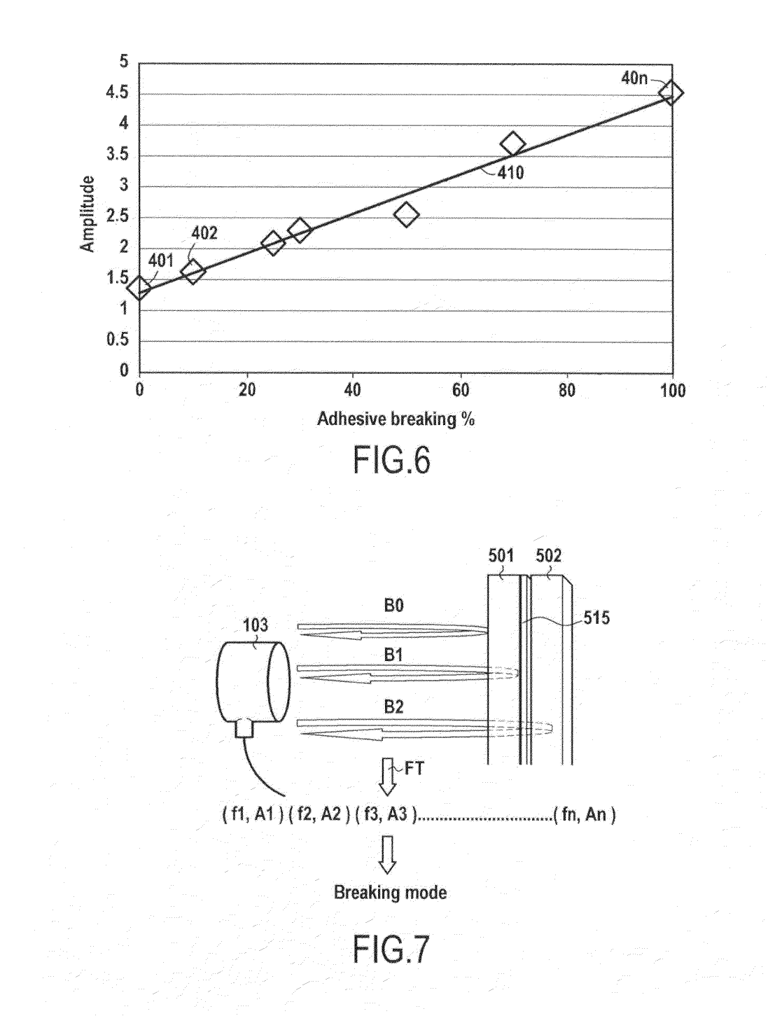

This measurement work is performed on a plurality of test-pieces using different adhesives, and it is found that a good quality linear relationship 410 exists between the percentage of adhesive breaking as observed visually in the images of FIG. 3, and the amplitude of the maximum 325 of the envelope as measured in FIG. 5. This relationship is shown by the graph of FIG. 6, which plots adhesive breaking percentage along the abscissa axis and the above-mentioned amplitude up the ordinate axis (a succession of points 401, 402, . . . , 40n, obtained for n test-pieces during the calibration stage).

Once this chart has been established, the method of the invention is performed on a real part made up of two fragments 501 and 502 that are adhesively bonded by a film 515, as shown in FIG. 7, and the invention is performed optionally on each real part produced, or else on parts selected at random for quality control purposes.

The fragment 501 has the same thickness as the fragment 101 that was used for preparing the chart.

The method consists in pointing the ultrasound transducer 103 towards the surface of a fragment 501 that is remote from the film 515. The transducer once more emits a longitudinal ultrasound wave propagating in a direction perpendicular to the interface constituted by the film of adhesive 515. A series of echoes B1 coming from within the thickness of the fragment 501 is recorded using the transducer 103 in transceiver mode, with the echo BO that is associated with the wave traveling the distance between the fragment 501 and the transducer 103 being excluded. Echoes are selected in the same manner as described above (FIG. 5), after which the Fourier transform (FT) of the resulting signal is obtained, and then the amplitude of the maximum of the envelope is read. This is referred to the chart of FIG. 6 in order to determine the expected adhesive rupture percentage for the assembly constituted by the part in question, and by taking the difference, the expected cohesive rupture percentage.

The invention is not limited to the implementations described, that extends to any variants within the ambit of the scope of the claims.

What is claimed is:

1. A method of characterizing an adhesive bond, the method comprising a step of recording an ultrasound wave reflected by an adhesive bond interface between two fragments, and a step of resolving said wave into its sinusoidal components in order to characterize a mode of breaking to be expected in the event of the adhesive bonding interface breaking in shear, wherein the amplitude of the sinusoidal component of maximum amplitude is compared with predetermined ultrasound wave amplitude values, and wherein the breaking mode is characterized by adhesive breaking and cohesive breaking percentages.

2. A characterization method according to claim 1, wherein the recording comprises recording at least seven successive echoes.

3. A characterization method according to claim 1, wherein a wave is generated in emission/reflection mode in order to obtain the reflected wave.

4. A characterization method according to claim 1, wherein a longitudinal wave is generated to obtain the reflected wave.

5. A characterization method according to claim 1, wherein the determination is performed by applying a linear relationship to the amplitude of the sinusoidal component of maximum amplitude.

6. A characterization method according to claim 1, performed on a real part of an aeroengine.

7. A characterization method according to claim 1, performed for developing an adhesive for bonding two fragments together.

8. A characterization method according to claim 1, wherein the electronic gate used for the recording has a field that includes the successive echoes in the material of the fragment through which the reflected wave passes, but not the echo from the interface between the fragment through which the reflected wave passes and the water between the ultrasound transducer emitting the wave and the surface of the fragment.
